(19) United States
(12) Patent Application Publication
(10) Pub. No.: US 2002/0147640 A1
(43) Pub. Date: Oct. 10, 2002

(54) System for obtaining credits for playing games and awarding and redeeming coupons

(76) Inventors: Laura Daniele, New York, NY (US); Joseph P. Lastella, Adelanto, CA (US)

Correspondence Address: CISLO & THOMAS, LLP, 233 WILSHIRE BLVD, SUITE 900, SANTA MONICA, CA, 90401-1211, US

(21) Appl. No.: 09/826,971

(22) Filed: Aug. 13, 2001

Related U.S. Application Data
(60) Provisional application No. 60/194,567, filed on Apr. 4, 2000.

(51) Int. Cl. G06F 17/60; A63F 9/24; A63F 13/00; G06F 17/00; G06F 19/00

(52) U.S. Cl. 705/14; 463/25

(57) ABSTRACT

A system for obtaining credits, e.g. from a bartering group, and converting them to credits for playing games, such as arcade games or other games, and for awarding and/or redeeming coupons, prizes and awards link barter dollars or other units belonging to an individual with credits for playing games or for redeeming coupons, awards and prizes. One or more barter networks are linked with a gaming server that accepts and exchanges barter dollars into credits. The various barter networks may be linked to a global network of which they are members, and the global network may then connected to the gaming server. Various combinations of these connections may be used. In addition, a card that carries data from the barter networks to the gaming server may be used in lieu of, or in addition to, the links. The gaming system may award coupons, which then may be used to select prizes. In certain circumstances the coupons, prizes or credits may be exchanged or converted back to the barter dollars or other form of value that the individual has used to obtain the gaming credits.

### CROSS-REFERENCES TO RELATED APPLICATIONS

This patent application is related to U.S. Provisional patent application Ser. No. 60/194,567 filed Apr. 4, 2000 for SYSTEM FOR OBTAINING CREDITS FOR PLAYING GAMES AND AWARDING AND REDEEMING COUPONS, which application is incorporated herein by this reference thereto.

### BACKGROUND OF THE INVENTION

The present invention is a system for obtaining credits, e.g., from a bartering group and converting them to credits for playing games, as in arcade games or other games, and awarding and redeeming coupons. The present invention links barter dollars or other units belonging to an individual with credits for playing games so that the individual can obtain credits to play, and also can be awarded coupons or other items for redemption. In a barter network, buyers and sellers (collectively “members”) exchange their goods and services for other members' goods and services of equal or different value. Members of the barter network can obtain credits to play games, and the game controller can award coupons to winners or debit their accounts in the gaming system. The coupons may be redeemed.

### SUMMARY OF THE INVENTION

In one embodiment, the invention involves linking one or more barter networks with a gaming server that accepts and exchanges barter dollars into credits. In another embodiment, various barter networks are linked to a global barter network of which they are members, and the global network is then linked to the gaming server. Various combinations of these connections may be used. In addition, a card that carries data from the barter networks to the gaming server may be used in lieu of or in addition to the links. The gaming system may award coupons, and these coupons may be used for selecting prizes. In certain circumstances they may be exchanged or converted back to the barter dollars or other form of value that the individual has used to obtain the gaming credits.

### BRIEF DESCRIPTION OF THE DRAWINGS

FIG. 1 is a diagram of a system including multiple barter networks, connected to a global barter network and then to a gaming server, to which some individuals (or businesses) who barter also subscribe;

FIG. 2 is similar to FIG. 1, but the barter networks are directly linked to the gaming server;

FIG. 3 is a diagram of details of certain portions of FIG. 1; and

FIG. 4 is a flow chart of operation of a gaming server suitable for use in FIG. 1 or FIG. 2.

### DETAILED DESCRIPTION OF THE PREFERRED EMBODIMENTS

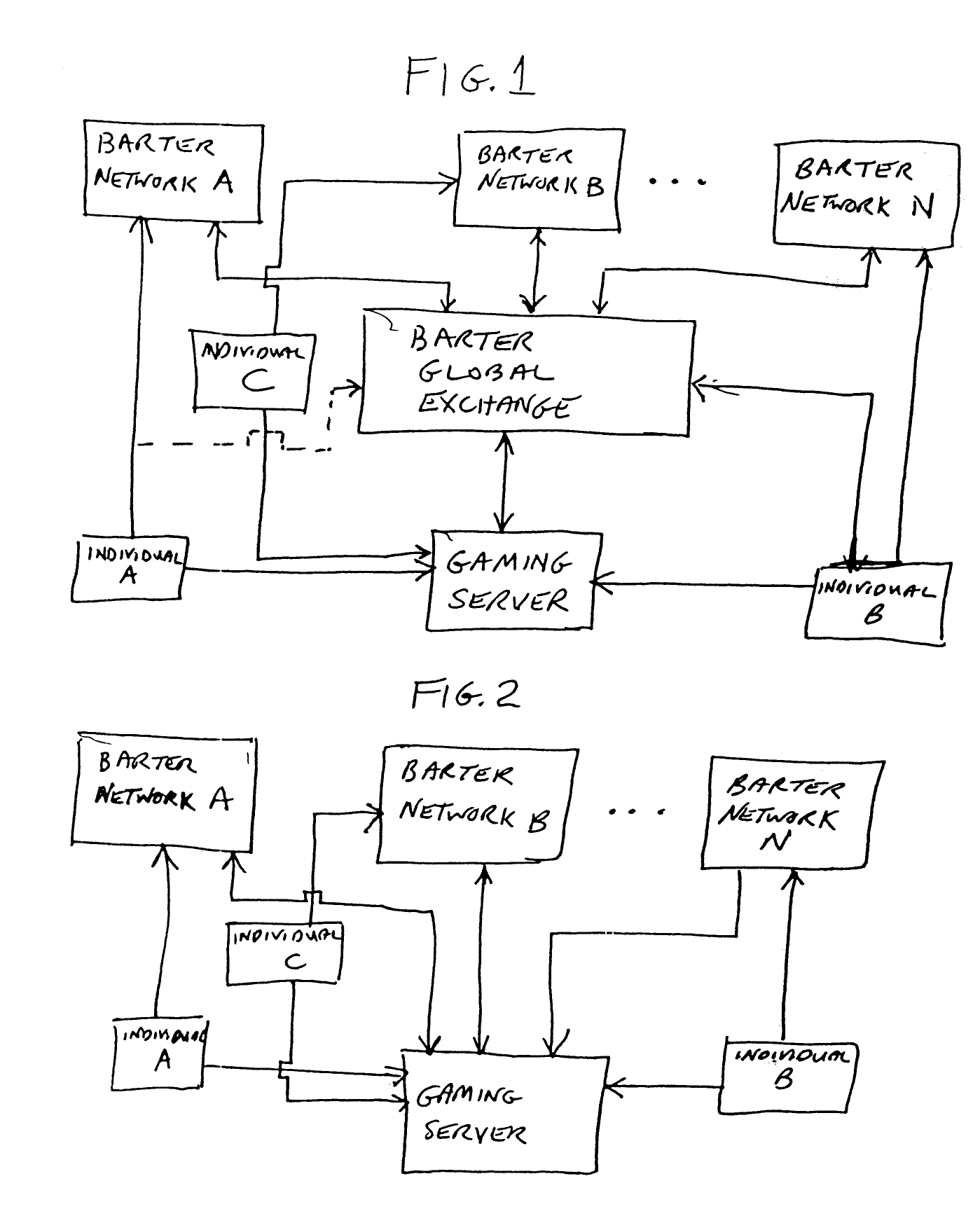

With reference to FIG. 1, a first embodiment of the invention is shown in the drawings. Various individuals (or companies or organizations) are members of various barter networks. As shown in the drawings, individual A is a member of barter network A, individual B is a member of barter network N and also a barter global exchange. Individual C is a member of barter network B.

The individuals connect to the various barter networks through a PC or equivalent with a data-carrying or transmitting link, as in the Internet. Individuals A, B and C may also like to play games such as arcade-style games or, where legal, gamble.

They also connect to a gaming network through data carrying or transmitting links, as in the Internet. These links may include a standard modem connection, DSL, cable, satellite or other means such as satellite, T1 lines, and radiofrequency. Instead of having to use real cash or dollars, the individuals tell the gaming server they want to play. The gaming server then looks for the barter credit in barter units of the individual on the barter networks specified by the individual user. For example, individual A would specify barter network A and the server would connect to barter network A to get the associated amount of barter dollar credit that individual A has selected.

Additional details of how the gaming and transfer of barter dollars, and conversion of such barter dollars to gaming credits, are discussed below.

It must be understood that when embodied in a lottery, gambling, sweepstakes or contest, appropriate laws must be considered, including but not necessarily limited to the laws of lottery, gambling, sweepstakes and contests. Depending upon which set of laws are to be satisfied, the barter networks could be understood to be banks or other financial institutions with accounts in dollars. The gaming server then converts the individual's incoming dollars, barter dollars, or other types of currency or value into gaming credits or credit units which may again, depending on the system desired, be exchangeable for money, barter dollars, coupons or tickets to be redeemed for prizes, or other types of credits.

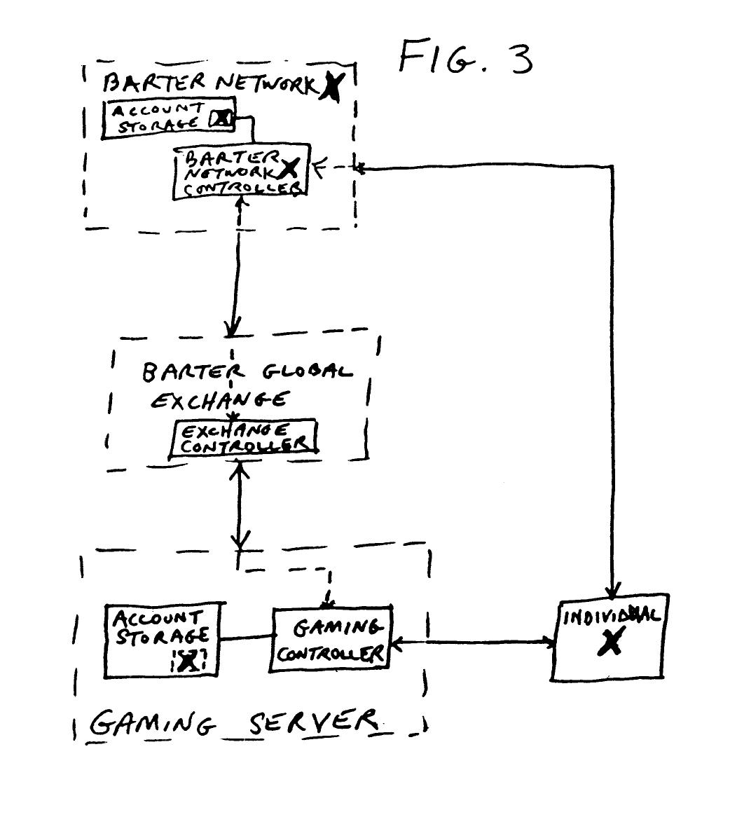

In the embodiment of FIG. 1, the gaming server is linked with a global exchange so that the gaming server only need perform a single conversion from barter dollars of the global exchange or other currency of the global exchange into gaming credits. In the FIG. 2 embodiment, the gaming server is linked with a number of different barter networks directly, and these may include a global exchange. In this case, the gaming server must perform appropriate conversions of currency, e.g., if the currency is money, it must convert Australian dollars, Eurodollars or other currencies into credits. In one embodiment, the gaming entity has an account at each barter network or other network which it directly links to so that users may have coupons or other winnings credited back to their barter account from the gaming server. In the embodiment of FIG. 1 where the barter global exchange is directly linked with the gaming server, the gaming server need only have an account with the barter global exchange, or automatically registered, to interact with the gaming server.

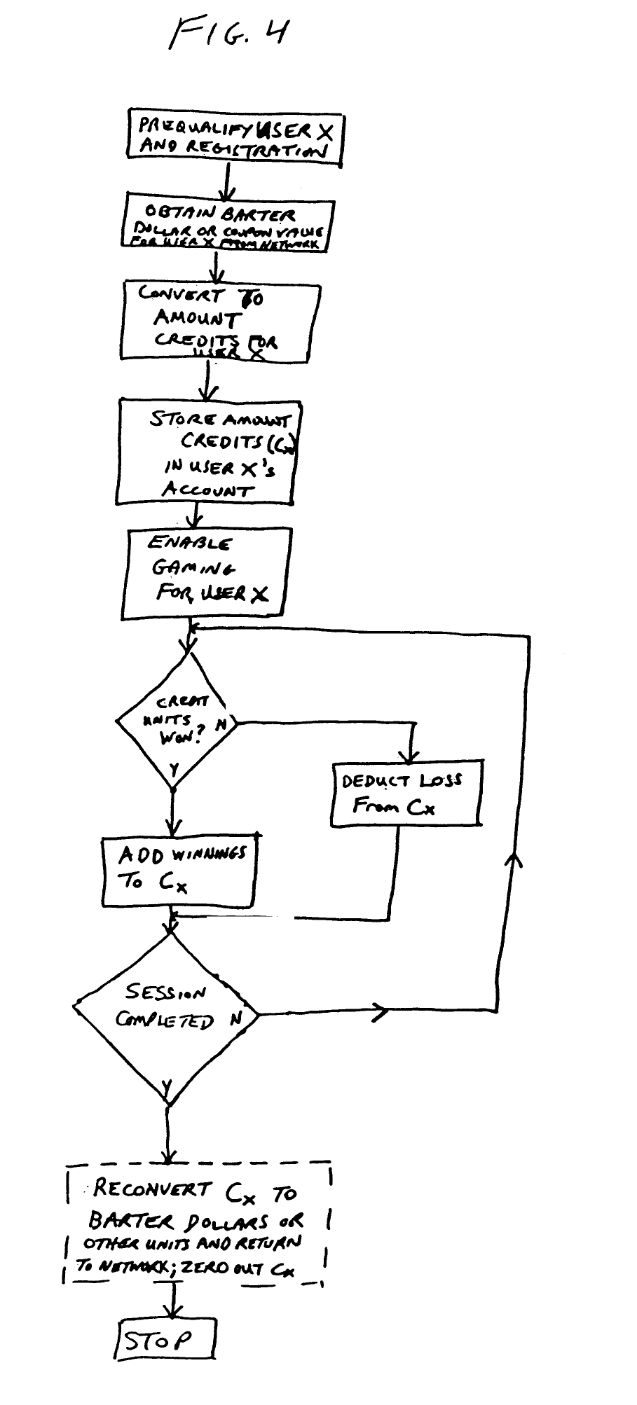

With reference to FIGS. 3 and 4, detailed steps in the process and control, and details of the gaming system, are shown and will be described. Individual X or user X is a member of barter network X. User X has an account in storage in barter network X. This account is in barter dollars. The example will be described for the case in which barter network X is a global exchange, where barter network X is a member of a global exchange, or where barter network X directly connects to the gaming server.

The first step in the process shown in FIG. 4 is to pre-qualify user X to game. If the gaming is gambling, a lottery or other process requiring a minimum age, the user must provide information to prove the age to the gaming controller. This can be part of a registration process. The registration process may include steps to verify the user's age and other information provided by the user, such as the barter network which the user is a member of, or other network. (It should be understood where the term ‘barter network’ is used herein, other networks or entities such as financial institutions may be substituted therefor.)

During the registration process, user X from his or her computer contacts the gaming controller in the gaming server, e.g., located at a specified domain name in a global network such as the Internet, and may also directly contact the barter network to provide authorization of a specific dollar amount or unit amount to be sent to the gaming server by the barter network. Alternatively, and particularly if the gaming server has an account at barter network X, user X may provide identifying information to the gaming server which may then be authorized to withdraw that amount from user X's account without user X having to contact the barter network X. Such an authorization preferably is encrypted. The gaming controller then obtains the barter dollar amount from the network. This may be directly obtained from the barter network, or may be obtained via the barter global exchange. This amount is converted into gaming credits and stored in account storage for user X at the gaming server. Where the gaming server goes through the global exchange, the global exchange's controller has already converted various barter dollars received from any of various barter networks into a standard barter dollar. Therefore, the gaming controller need only perform the conversion into credits without taking into account exchange rates. Otherwise, the gaming controller must take into account exchange rates.

Once the amount of credits is stored in account storage for user X in the gaming server, gaming is enabled for user X. The gaming controller will allow user X to select and play whatever appropriate game user X is able to play. Where the gaming server is using gambling games, these may include keno, slot machines, sports betting, lottery, horse racing, poker, blackjack, and all other gambling games such as those played in Las Vegas, Atlantic City or elsewhere. Other games, such as electronic and video games, like in an arcade or on a computer, may be used.

User X plays the games and wins or loses. While user X plays, the gaming controller adds any winnings to the credits (e.g., coupons) of user X in the account storage for user X, these credits or coupons being denominated Cx in FIG. 4. If the session continues, the loop where credits are won or loss and deducted or added to user X's account in the gaming server continues. When the session is completed, there are several options that may occur. The gaming controller may take user X's amount Cx, convert it back to whatever units user X originally had sent to the gaming controller, and return that amount of units back to the barter network, barter global exchange, bank or wherever it came from. This return would, in one embodiment, come from the gaming server's local account at the barter global exchange, barter network or other institution where it has an account. The gaming controller would then zero out its account storage for user X. Alternatively, user X might have an opportunity to keep a certain amount or the whole amount in storage in the gaming server. Also alternatively, the reconversion step is optional and the gaming server may be set up such that once credits or coupons are obtained, they cannot be converted back and returned. Instead, these credits or coupons may be used or redeemed for prizes or other remuneration, such as toys, dolls, airfare, hotel rooms, food, and credits to play more games.

Many variations of the above-described embodiments are possible. For example, there may be a rebate or lottery option where after a period of time, the gaming server selects certain individuals for rebate or lottery. This may, for example, be in the form of the gaming controller selecting the top loser or a percentage of top losers during a given time, such as the last hour, day, week, month, etc. For example, the top two losers in the last hour of play may be credited all or a percentage of their losings back into their accounts in the gaming server. This could also be a random lottery. At random times the gaming controller could select the top loser or top losers and send credits or coupons back to the account storage. It is even possible to provide a different type of remuneration for the losers. For example, even though they may have originally put in barter dollars or actual monetary currency to obtain their credits or coupons in account storage, they may be credited back with a type of coupon which might only be available for selection or redemption of certain prizes from the gaming server itself, rather than being a type of credit that could be reconverted and sent back to the individual's account where the original barter dollars or other currency came from.

Merely for purposes of explanation, the barter networks typically operate by a user trading in goods or services and obtaining barter dollars. How the barter networks work is well known in the art.

As an alternative to linking the gaming server with the barter networks, or in addition thereto, a linking card rather than a link via a global or local network may be used. The linking card would be a card capable of storing varying amounts and also preferably information about the user such as a security code, and the user's name. The user would obtain certain barter dollars on the card or other currency, and then take the card and provide it to the gaming server. A selected amount of credits may be used. When the user wins, in the case where winnings are credits back to the user's original type of currency, the linking card may then be credited with an appropriate amount.

What is claimed is:

1. A method for obtaining credits from a bartering group and for converting the credits to credits for playing games, or for awarding or redeeming coupons or prizes, awards and the like, the method comprising the steps of:
a. pre-qualifying a user;
b. obtaining a first amount of barter units for the user from a barter network;
c. converting the first amount of barter units to an amount of credits for the user;
d. storing the amount of credit in a user's account on a gaming server; and
e. enabling gaming for the user on the gaming server.

2. The method of claim 1, including the step of adding any user's credit winnings to the amount of credit in the user's account on the gaming server.

3. The method of claim 1, including the step of deducting any user's credit losses from the amount of credit in the user's account on the gaming server.

4. The method of claim 1, including the step of re-converting a remaining amount of credit in the user's account on the gaming server into a second amount of barter units.

5. The method of claim 4, including the step of returning the second amount of barter units to the barter network.

6. The method of claim 5, further including the step of zeroing out the user's account on the gaming server after the step of returning the second amount of barter units to the barter network.

7. The method of claim 1, wherein the step of pre-qualifying the user comprises verifying the user's age.

8. The method of claim 1, wherein the user directly contacts a gaming controller located on the gaming server.

9. The method of claim 8, wherein the gaming controller is located at a specified domain name on a global network.

10. The method of claim 9, wherein the global network is the Internet.

11. The method of claim 1, wherein the user directly contacts the barter network to provide authorization for the barter network to send a specific portion of the first amount of barter units to the gaming server.

12. The method of claim 1, wherein the user provides identifying information directly to the gaming server to authorize the gaming server to withdraw a specific portion of the first amount of barter units from the barter network.

13. The method of claim 12, wherein the authorization is encrypted.

14. A system to link barter units belonging to a user with credits, such that the user can obtain credits to play games or can be awarded or can redeem coupons, awards, prizes or other renumeration, comprising:
a. one or more barter networks;
b. a gaming server that accepts and exchanges barter units into credits; and
c. means for linking the barter network to the gaming server for connecting a user or users of the barter network to the gaming server.

15. The system of claim 14, wherein the means for linking the barter network to the gaming server is a personal computer (PC) with a data-transmitting link.

16. The system of claim 15, wherein the data transmitting link is the Internet.

17. The system of claim 14, wherein the means for linking the barter network to the gaming server is a card that carries data from the barter network to the gaming server.

18. The system of claim 14, wherein the barter network is linked to the gaming server through a global exchange.

19. The system of claim 14, including a means for assigning a user a unique account, and means for storing the user's unique account information on the gaming server.

20. The system of claim 19, wherein the means for storing the user's account information on the gaming server comprises a means for indexing the user's account information to player identification data.

21. The system of claim 20, further comprising a means for accumulating player reward points that are associated with the player identification data.

22. A system to link barter units belonging to a user with credits, such that the user can obtain credits to play games or to be awarded or redeem coupons, prizes or other remuneration, comprising:
a. at least one barter network associated with at least one user, the barter network having a first account storage means and a barter network controller;
b. a barter global exchange, the barter global exchange having an exchange controller and being linked to the barter network; and
c. a gaming server having a second account storage means and a gaming controller, the gaming server being linked to the user and to the barter global exchange, wherein the user has an account in the barter network in barter units, and the barter network is a member of the global exchange.

23. A method for obtaining credits from a bartering group and for converting the credits to credits for playing games, or for awarding or redeeming coupons or prizes, awards or other remuneration, the method comprising the steps of:
a. pre-qualifying a user having identifying information by providing the identifying information to a gaming server;
b. obtaining a first barter unit value for the user;
c. converting the first barter unit value to an amount of credits for the user;
d. storing the amount of credit in a user's unique account on the gaming server; and
f. enabling gaming for the user on the gaming server;
g. adding any winnings to the user's account on the gaming server;
h. deducting any losses from the user's account on the gaming server; and
re-converting the amount of credit remaining in the user's account on the gaming server to a second barter unit value.

24. The method of claim 23, wherein at least a portion of the second barter unit value is sent to a barter network.

25. The method of claim 23, wherein at least a portion of the second barter unit value is sent to a barter global exchange.

26. The method of claim 23, wherein at least a portion of the second barter unit value is kept in the user's account on the gaming server.
